(19) United States
(12) Patent Application Publication
(10) Pub. No.: US 2006/0293906 A1
(43) Pub. Date: Dec. 28, 2006

(54) Method of developing a plan for replacing a product component using a scanning process

(75) Inventors: Peter A. Wilson, Florissant, MO (US); Daniel J. Sherwinter, St. Louis, MO (US); Craig M. Farniok, Godfrey, IL (US); Timothy Stumpf, St. Charles, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: The Boeing Company

(21) Appl. No.: 11/165,978

(22) Filed: Jun. 24, 2005

(51) Int. Cl. G06Q 99/00; G05B 19/418; G06F 15/02; G06F 9/46

(52) U.S. Cl. 705/1; 705/8; 705/9

(57) ABSTRACT

A method of developing a plan for repairing an aircraft by attaching a replacement part to a receiving portion of the aircraft comprises scanning the receiving portion of the aircraft to acquire information about at least one of dimensions, a position, and an orientation of the receiving portion. The method further comprises scanning a plurality of potential replacement parts to acquire dimensional information about the potential replacement parts. The method also comprises creating a repair plan including processing the information acquired in the scanning steps to identify a preferred replacement part of the plurality of potential replacement parts for attaching to the receiving portion of the aircraft.

### BACKGROUND OF THE INVENTION

The present invention relates to a method of developing a plan for repairing a product and, more particularly, to a method of developing a plan for repairing a product using a scanning process to identify a preferred replacement part.

Product repairs often involve replacing a defective or damaged part with a replacement part. To save cost and time, replacement parts are sometimes obtained from used products. For example, a damaged vertical tail of an aircraft can be replaced with a undamaged tailfin from an aircraft taken out of commission for other reasons (e.g., having a damaged fuselage). Due to high tolerance requirements of many assembled products, interchangeability of product parts is often difficult. When attachment features on the replacement part do not align with mating attachment features on the product, various measures must be taken to obtain an acceptable fit. For example, holes in the product may need to be enlarged and other interface characteristics may need to be reshaped to allow the part to fit to the product. The work required for fitting a part that does not easily mate to the receiving product can be costly and time consuming.

Fit problems occur during original manufacture as well. A very small dimensional variation from specifications in a new part or product can result in an improper fit. As a result, the part and/or product must be altered to allow fit, other parts must be tried on the product, or the product must be discarded. Whether a part and product are new or used, a method of accurately matching and mating parts with the products is needed to improve repair/manufacturing cycle time, and cost margins and to ensure products are within desired tolerances.

### BRIEF SUMMARY OF THE INVENTION

The present invention relates to a method of developing a plan for repairing an aircraft by attaching a replacement part to a receiving portion of the aircraft. The method comprises scanning the receiving portion of the aircraft to acquire information about at least one of dimensions, a position, and an orientation of the receiving portion. The method further comprises scanning a plurality of potential replacement parts to acquire dimensional information about the potential replacement parts. The method also comprises creating a repair plan including processing the information acquired in the scanning steps to identify a preferred replacement part of the plurality of potential replacement parts for attaching to the receiving portion of the aircraft.

In another aspect, the present invention includes a method of developing a plan for repairing a product having a receiving portion and a defective part mounted on the receiving portion. The method comprises scanning the receiving portion of the product to acquire information about at least one of dimensions, a position, and an orientation of the receiving portion. The method further comprises scanning a plurality of potential replacement parts to acquire dimensional information about the potential replacement parts. The method also comprises creating a repair plan including processing the information acquired in the scanning steps to identify a preferred replacement part of the plurality of potential replacement parts for mounting to the product at the receiving portion of the product in place of the defective part.

Other aspects of the present invention will be in part apparent and in part pointed out hereinafter.

### BRIEF DESCRIPTION OF THE DRAWINGS

FIG. 1 is a flow diagram of a process according to a first embodiment of the present invention.

FIG. 2 is a perspective of an aircraft, a damaged part of the aircraft, and a replacement part for the aircraft.

FIG. 3A is a cross section of a first potential replacement part.

FIG. 3B is a cross section of a second potential replacement part.

FIG. 4 is a flow diagram of a process according to a second embodiment of the present invention.

Corresponding reference characters indicate corresponding parts throughout the several views of the drawings.

### DETAILED DESCRIPTION OF THE INVENTION

The present invention relates to a method of developing a plan for repairing a product and, more particularly, to a method of developing a plan for repairing a product using a scanning process to identify a preferred replacement part. Reference will now be made in detail to an implementation in accordance with methods, systems, and articles of manufacture consistent with the present invention as illustrated in the accompanying drawings. Methods, systems, and articles of manufacture consistent with the present invention allow accurate repair and manufacture of aircraft. Although use of the methods, systems, and articles of manufacture consistent with the present invention are primarily discussed with reference to aircraft, they may be applied to improve repair and manufacturing of other products (e.g., automobiles, tanks, ships, and other multi-component assemblies) without departing from the scope of the present invention.

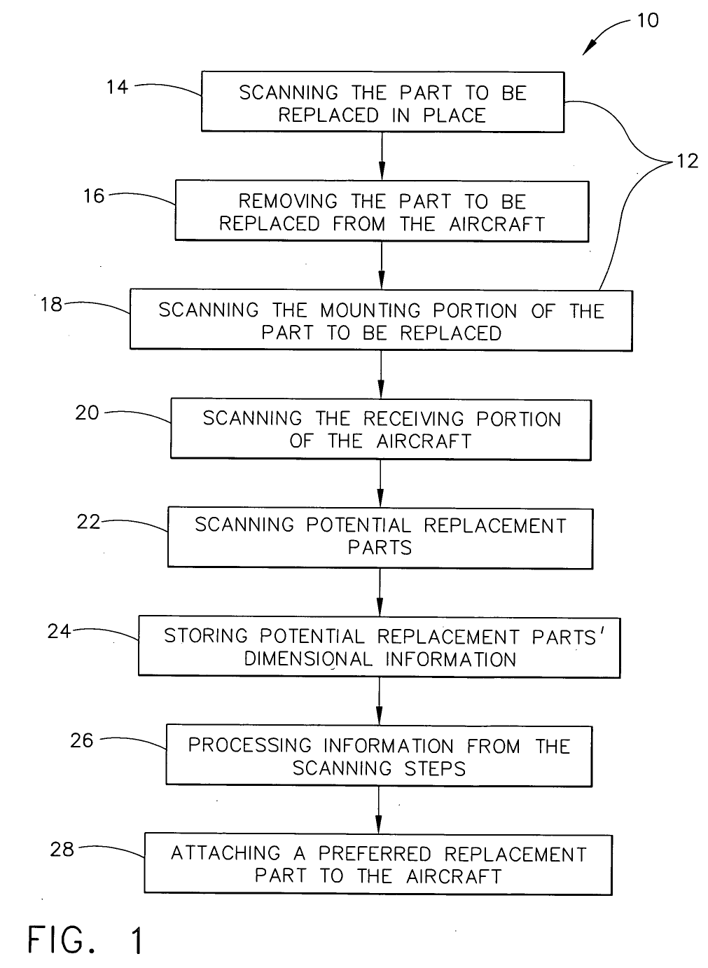

Referring now to the figures, and more particularly to FIG. 1, a process according to a first embodiment of the present invention is designated in its entirety by reference number 10. One or more machines are used to implement the methods of the present invention. In one embodiment, the machines include a scanning device, part-positioning equipment, and fastening equipment. All or some of the machines may be automated. That is, each machine can have the ability to perform its function automatically, without manual assistance after being started.

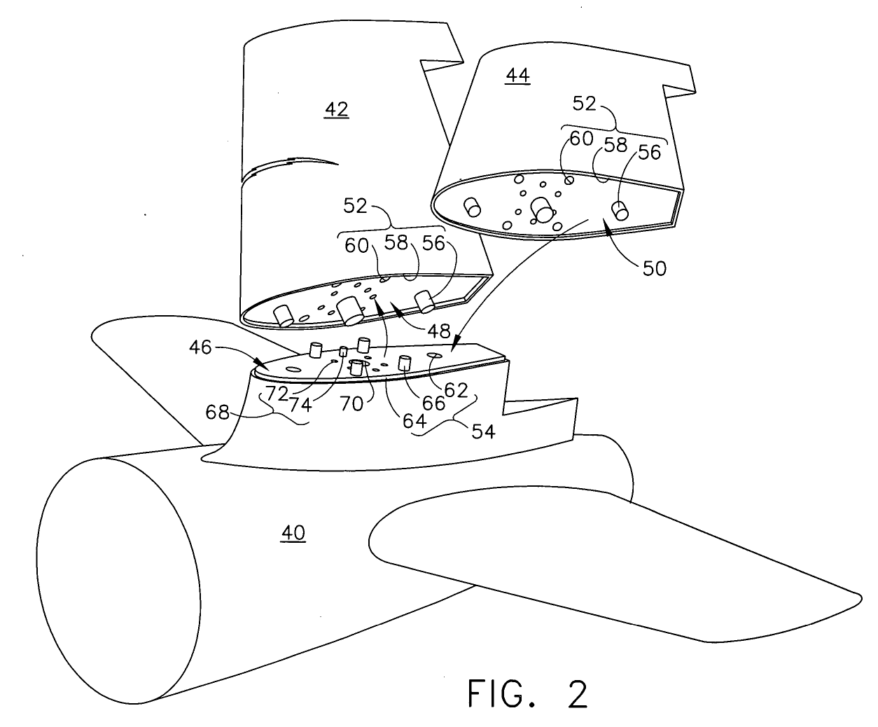

The process 10 includes scanning 12 a part of an aircraft (e.g., a tail fin as shown in FIG. 2) needing replacement using a scanning device (not shown) to acquire information about at least one of dimensions, a position, and an orientation of the part. The information acquired by scanning 12 the part to be replaced can be stored for subsequent retrieval and processing. The part to be replaced may be, for example, a defective part, a damaged part, or a part for which a new version is being substituted. Although the scanning device may be another type without departing from the scope of the present invention, in one embodiment the scanning device is a conventional laser scanning or tracking device such as a Laser Tracker II Plus, available from Automated Precision, Inc., of Rockville, Md. Conventional camera vision devices, white light devices, articulating arm devices having a point or contact probe, articulating arm devices having a laser scanning probe, radar devices, and other metrology tools can also be used to perform the scanning step 12.

The part to be replaced can be scanned 12 in a variety of ways. One way to scan the part to be replaced is to scan 14 the part while it is mounted on the aircraft to acquire information about position and/or orientation of the part. That is, the scanning device is used to determine the position and/or orientation of the part to be replaced with respect to the aircraft it is mounted on before it is removed from the aircraft. The positional and/or orientational information acquired by scanning 14 the part to be replaced in place (i.e., while it is mounted on the aircraft) can be helpful for accurately attaching a replacement part (not shown in FIG. 1) to the aircraft. For example, the replacement part can be positioned and oriented with respect to the aircraft in the same manner as the part to be replaced was positioned and oriented. Scanning 14 the part to be replaced in place can also be performed to acquire dimensional information about the part, such as information about damage. It is envisioned that information regarding damaged parts can be stored to determine, for example, trends of damage types. After the part to be replaced has been scanned 14 in place, it is removed 16 from the aircraft. Once the part to be replaced has been removed 16 from the aircraft, a mounting portion of the part, which interfaces with a receiving portion of the aircraft when the part is in place, is scanned 18 to acquire dimensional information about the mounting portion. Dimensional information about the mounting portion of the part to be replaced can be used to identify one or more preferred replacement parts from multiple replacement part candidates.

The process 10 further includes scanning 20 the receiving portion of the aircraft to acquire information about the dimensions, a position, or an orientation of the receiving portion. Scanning 20 the aircraft can be performed using any of a variety of scanning devices as previously described. For example, the receiving portion of the aircraft may be scanned 20 after the part to be replaced is removed and before a replacement part is attached. The information about the receiving portion of the aircraft will be used to identify one or more preferred replacement parts from multiple replacement part candidates.

The process 10 also includes scanning 22 potential replacement parts (not shown in FIG. 1) to acquire dimensional information about the parts. The replacement parts can be newly manufactured or used. Scanning 22 the potential replacement parts can also include acquiring positional and/or orientational information about the parts. For example, regarding used replacement parts, the parts can be scanned 22 for position and orientation when mounted on an aircraft the part was being used on. The information acquired by scanning 22 the potential replacement parts is digitized and stored 24 in a database for subsequent retrieval and processing. Although the database may be maintained in other places without departing from the scope of the present invention, in one embodiment the database is maintained in a conventional personal computer (not shown). The information acquired in the scanning steps 14, 18, 20, 22 can be stored, managed, or otherwise controlled using one or more data management systems, such as a data server or product data manager.

After the scanning steps 14, 18, 20, 22, the process 10 includes a step 26 of processing the information acquired in those steps to identify a preferred replacement part of the multiple potential replacement parts scanned 22. In one embodiment, the processing 26 is performed by a data processor (not shown). Although the data processor may be another type without departing from the scope of the present invention, in one embodiment the data processor is a conventional personal computer having Polyworks, available from Innovmetric, of Sainte-Foy, Quebec, Canada. It is envisioned the storing step 24 and the processing step 26 may be performed using a single computer or system of computers. In one embodiment, the programmed software includes a best fit algorithm to select a preferred replacement part. The algorithm may be any best fit algorithm known in the art. In one embodiment, the algorithm includes specifications that prioritize potential replacement parts based on variations each part is determined to require with respect to an optimal part location. For example, considering that positional variables include X, Y, Z, pitch, roll, and yaw directions, a particular repair specification may only allow changes in the yaw direction as a last resort, require a special inspection of the product if any change is made in the Z direction, and restrict movement in all other directions to certain ranges. Under this repair specification, the best fit algorithm would prefer parts that do not require position changes in either the yaw or Z directions and that only required changes in the other directions within the allowable ranges. In another embodiment, the programmed software selects a preferred replacement part based on preferences programmed into the software. For example, the software can include a hierarchy of variables whereby particular dimensional aspects of a potential replacement part are preferred over others. The programmed preferences include, but are not limited to, engineering requirements, such as allowable degrees of freedom, and design requirements, such as the necessity of a particular minimum clearance or edge distance. It is envisioned the processing step 26 may include identifying more than one of the potential replacement parts as preferred. It may be beneficial to have multiple preferred replacement parts in the event the most preferred part becomes unavailable. When more than one preferred replacement part is identified, the identified parts can be ranked from most to least preferred.

The processing step 26 further includes creating a plan for repairing the aircraft. Creating the repair plan can include developing a schedule for delivering the preferred replacement part to a location of the aircraft for attachment thereto. For example, once identified, a preferred replacement part can be scheduled for transport on an already planned shipment of other parts from a location of the replacement part to the location of the aircraft. The repair plan can also include procurement of hardware or a kit of hardware needed for the repair, such as necessary tooling and fasteners. For example, based on the information acquired by scanning 12, 20, 22, the data processor may determine that a small drill and drill bit of particular diameter (not shown) are required to slightly enlarge a hole in the receiving portion of the aircraft. Lead times for procuring rare or custom tooling, fasteners, and other hardware can have a significant impact on the cycle time of repair. The repair plan can also include identification of personnel needed to attach the preferred replacement part to the aircraft. For example, if work required to attach the replacement part to the aircraft can only be done by certified individuals, then those individuals can be identified. In these ways, efficient procurement can save time, resources, and costs in the repair process. The information acquired in the scanning steps 14, 18, 20, 22 can also be used for other predictive analyses, such as determining needs for downstream manufacture or repair.

The process 10 further includes attaching 28 the preferred replacement part to the receiving portion of the aircraft in place of the defective part. The attaching step 28 can include using the dimensional, positional, and/or orientational information acquired by scanning 14 the part to be replaced in place to position and orient the preferred replacement part on the aircraft. For example, the preferred replacement part can be positioned and oriented as close as possible to the manner in which the part to be replaced was positioned and oriented when it was mounted on the aircraft. In one embodiment, the positional and orientational data from the part to be replaced is used in the attaching step 28 by scanning the preferred replacement part during positioning and moving the preferred replacement part until it is in the desired position and orientation, as confirmed by feedback from the real time scanning. In another embodiment, the positional and orientational data from the part to be replaced is used in the attaching step 28 by projecting lasers corresponding to the desired position and orientation around the preferred replacement part so the replacement part is properly positioned and orientated when it matches up with the projections.

Positioning and orienting using the digitized positioning data can be performed using relatively simple or “soft” tools instead of the heavy and expensive “hard” tools often needed in conventional part replacement processes. One type of hard tool is a robust framework that contacts the aircraft and part to be replaced at various points to identify the position of the part with respect to the aircraft. The framework is designed to allow removal of the part to be removed. When mounting the replacement part to the aircraft, the replacement part is positioned by mating it with the contact features of the framework corresponding to the position of the part to be replaced. Soft positioning tools, on the other hand, are only needed to prop the preferred replacement part adjacent the desired position so the part can be slightly maneuvered into proper position. The type of soft positioning tool(s) used varies depending on the application. Soft tools can be light scaffolding, a crane, or even more common manufacturing implements, such as a sawhorse or dolly. Soft and hard tools can be specially developed for particular applications. Methods of manufacturing such tools include machining, forging, hydro-forming, selective laser sintering (SLS), directed metal disposition (DMD), and laminate object manufacturing (LOM). These methods may be used in various combinations or with other manufacturing techniques. For example, a tool created with SLS may be back-filled with concrete for added strength. Before and after the preferred replacement part has been positioned and oriented, the part and/or the aircraft can be worked as needed to facilitate proper mating between the part and the aircraft. For example the mounting portion of the preferred replacement part and the receiving portion of the aircraft can be drilled, cut, or otherwise modified for better fit between the two. Although the aircraft and/or preferred replacement part may require working during the attaching step 28 to obtain a proper fit, the amount of work and time needed to perform the repair will generally be less than would be needed to attach a random replacement part. After the preferred replacement part and aircraft are prepared, positioned, and oriented as desired, the part is fastened to the aircraft.

In one embodiment, the processing step 26 includes creating an apply template (not shown). An apply template is a representation of at least a portion of an object that can be measured, moved, compared to other objects, and otherwise analyzed with relative ease. For example, a physical mold can be made of the receiving portion of the aircraft using the dimensional information acquired in the scanning step 20. Apply templates can be used in a variety of ways. For example, measurements taken from a template can be used to identify a preferred replacement part. The template can also be used during the attaching step 28. For example, information about how a potential part and the receiving portion of the aircraft would interact during mating of the two can be acquired using transparent templates or templates representing only part of a scanned interface, thereby allowing a partial cross-sectional view of the mating features.

Although shown and discussed in a particular order, those skilled in the art will appreciate the pre-attachment steps 12, 16, 20, 22, 24, 26 of the process 10 can be performed in various orders. For example, in one embodiment, the potential replacement parts may be scanned 22 before the part to be replaced and aircraft are scanned 12, 20. Further, the process may be performed without scanning 12 the part to be replaced.

FIG. 2 shows a tail section of an aircraft 40, a part to be replaced 42, and a preferred replacement part 44 selected from multiple potential replacement parts (not shown). In this embodiment, the part to be replaced 42 and the replacement parts are vertical stabilizers or tailfins. The aircraft 40 includes a receiving portion 46, from which the part to be replaced 42 is removed in the removing step 16 and to which the preferred replacement part 44 is attached in the attaching step 28. The part to be replaced 42 and each replacement part have respective mounting portions 48, 50 shaped to interface with the receiving portion 46 of the aircraft 40. For example, the mounting portions 48, 50 may have physical characteristics 52 corresponding to physical characteristics 54 of the receiving portion 46. In one embodiment, the mounting portions 48, 50 have attachment points or features including protrusions 56, edges 58, and openings 60 that correspond to attachment points or features including openings 62, edges 64, and protrusions 66 of the receiving portion 46. Other possible physical characteristics include fasteners, grooves, and dagger pints. The steps 18, 20, 22 of scanning the parts and aircraft can include identifying and digitizing the positions of these characteristics 52, 54. Identifying the location of physical characteristics 52, 54 of the mounting and receiving portions can be facilitated by using additional locating characteristics 68. For example, to better identify the location of a center hole 70 of the receiving portion holes 62, multiple locating holes 72 can be formed in the receiving portion 46 around the center hole. These locating holes 72 can aid in the process of locating the center hole 70 by being scanned 20 themselves. For example, six locating holes 72 can be scanned 20 to completely or more accurately locate the center hole 70 through interpolation between the locating holes. Additional locating characteristics can also include locating pins 74 temporarily inserted into the surrounding holes 72. Locating the locating pins 74 is another way to accurately locate the center hole 70.

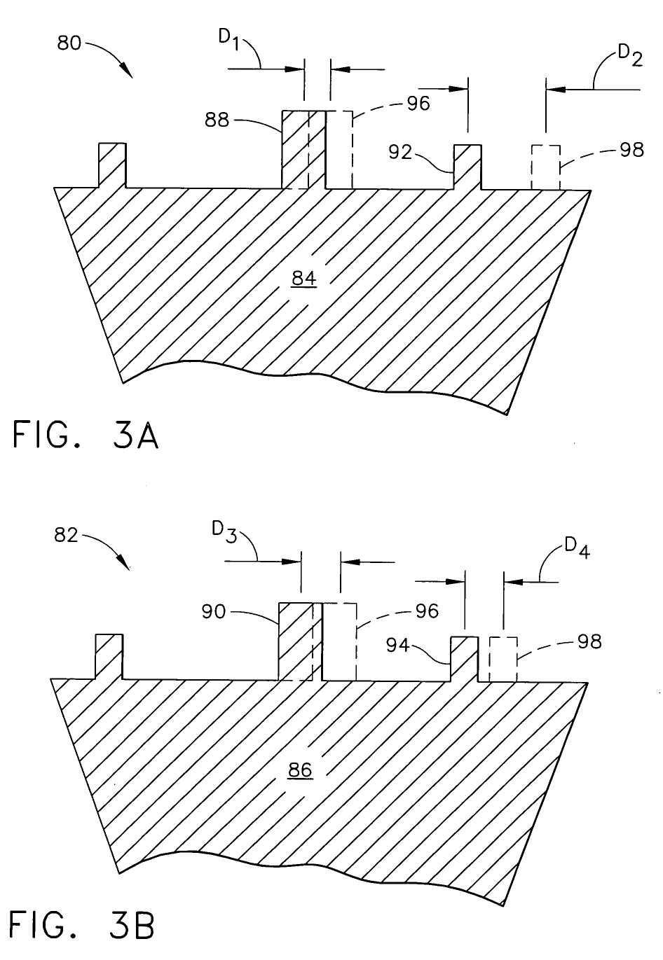

As discussed above, preferences can be programmed into the software for use during the processing step 26. As an example, FIGS. 3A and 3B respectively show mounting surfaces 80, 82 of first and second potential replacement parts 84, 86. Each mounting surface 80, 82 includes a first pin 88, 90 and a second pin 92, 94. The first pin 88 of the first potential replacement part 84 is spaced from a desired location 96 (i.e., the location that would allow the pin to exactly match up with a corresponding hole in the aircraft) by a distance D₁ of about one inch. The second pin 92 of the first potential replacement part 84 is spaced from its desired location 98 by a distance D₂ of about three inches. Each of the first and second pins 90, 94 of the second potential replacement part 86 are spaced from the respective desired locations 96, 98 by a distance D₃, D₄ of about one and a half inches. The identification of a preferred part can be performed by comparing the measured values from the scanning steps to the hierarchy programmed into the data processor. For example, the software can be programmed to prefer that the first pin 88, 90 be as close to its desired location 96 as possible, despite the distance D₂, D₄ between the second pin 92, 94 and its desired location 98. Under these conditions, the first potential replacement part 84 will be preferred over the second potential replacement part 86 because D₁ is less than D₃. As another example, the software can be programmed to prefer that the distance D₁, D₃ separating the first pin 88, 90 from its desired location 96 and the distance D₂, D₄ separating the second pin 92, 94 from its desired locations 98 are both below two inches. Under these conditions, the second potential replacement part 86 will be preferred over the first potential replacement part 84. In one embodiment, programmed preferences consider the direction in which characteristics of the mounting portion part are displaced from their desired locations. As will be appreciated by those skilled in the art, the data processor used in the processing step 26 can be programmed with any of innumerable algorithms for selecting one preferred replacement part or identifying and ranking multiple potential replacement parts based on information acquired in the scanning step 12, 20, 22.

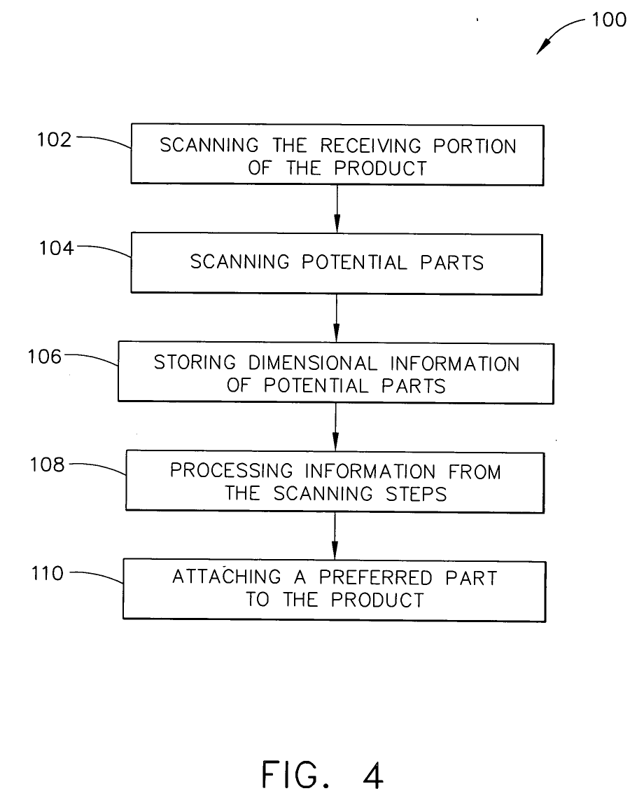

FIG. 4 shows a process 100 according to the present invention for manufacturing a product whereby a preferred part is identified from a group of multiple potential parts and attached to a part receiving portion of the product (product and parts not shown). The process 100 comprises a step 102 of scanning the receiving portion of the product to acquire dimensional, positional, and/or orientational information about the receiving portion. For example, a scanning device (not shown) can be used to identify the location of attachment features of the receiving portion of the product. The process 100 further includes a step 104 of scanning multiple potential parts to acquire dimensional information about each potential part. For example, a scanning device can be used to identify the location of attachment features of a mounting portion of each potential part, which correspond to the attachment features of the receiving portion of the product. The potential parts can be scanned 104 before, during, and/or after the product is scanned 102. It is envisioned the steps 102, 104 of scanning the product and potential parts can be performed using the same scanning device. The information acquired from scanning 104 the potential parts may be stored 106 in a database, such as in a personal computer, for subsequent retrieval and processing. The information acquired by scanning 102 the product can also be stored. After the scanning steps 102, 104, the information acquired therein is processed 108 to identify a preferred part from the potential parts. More than one preferred part may be identified. When more than one preferred part is identified, the identified parts can be ranked from most to least preferred. After the preferred part is identified, it is transported to the product and attached 110 thereto. The devices for scanning, storing information, and processing information and ways for using them are otherwise identical to the devices and ways for using those devises of the first embodiment, and therefore will not be described in further detail.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A method of developing a plan for repairing an aircraft by attaching a replacement part to a receiving portion of the aircraft, the method comprising:
scanning the receiving portion of the aircraft to acquire information about at least one of dimensions, a position, and an orientation of the receiving portion;
scanning a plurality of potential replacement parts to acquire dimensional information about the potential replacement parts; and
creating a repair plan including processing the information acquired in the scanning steps to identify a preferred replacement part of the plurality of potential replacement parts for attaching to the receiving portion of the aircraft.

2. A method of developing a plan for repairing a product having a receiving portion and a defective part mounted on the receiving portion, the method comprising:
scanning the receiving portion of the product to acquire information about at least one of dimensions, a position, and an orientation of the receiving portion;
scanning a plurality of potential replacement parts to acquire dimensional information about the potential replacement parts; and
creating a repair plan including processing the information acquired in the scanning steps to identify a preferred replacement part of the plurality of potential replacement parts for attaching to the receiving portion of the product in place of the defective part.

3. A method of developing a plan for repairing a product as set forth in claim 2 wherein creating the repair plan further includes identifying at least one fastener for use in attaching the preferred replacement part to the product.

4. A method of developing a plan for repairing a product as set forth in claim 2 wherein creating the repair plan further includes identifying tooling for use in attaching the preferred replacement part to the product.

5. A method of developing a plan for repairing a product as set forth in claim 2 wherein creating the repair plan further includes identifying personnel to attach the preferred replacement part to the product.

6. A method of developing a plan for repairing a product as set forth in claim 2 wherein creating the repair plan further includes developing a schedule for delivering the preferred replacement part to a location of the product for attachment to the product.

7. A method of developing a plan for repairing a product as set forth in claim 2 wherein at least one of said scanning steps is performed using a laser tracking device.

8. A method of developing a plan for repairing a product as set forth in claim 2 wherein said scanning steps include determining a location of at least one opening in the receiving portion and at least one opening in each potential replacement part.

9. A method of developing a plan for repairing a product as set forth in claim 2 wherein said scanning steps include determining a location of at least one edge of the receiving portion and at least one edge of each potential replacement part.

10. A method of developing a plan for repairing a product as set forth in claim 2 further comprising storing information acquired from scanning the potential replacement parts in a database for subsequent retrieval and processing.

11. A method of developing a plan for repairing a product as set forth in claim 2 further comprising attaching the preferred replacement part to the receiving portion of the product.

12. A method of developing a plan for repairing a product as set forth in claim 2 wherein scanning each potential replacement part includes scanning a mounting portion of the potential replacement part, the mounting portion being shaped to interface with the receiving portion of the product.

13. A method of developing a plan for repairing a product as set forth in claim 12 wherein said mounting and receiving portions include corresponding attachment features and said scanning steps include identifying said attachment features.

14. A method of developing a plan for repairing a product as set forth in claim 2 wherein the product includes a part to be replaced mounted on the receiving portion of the product and the method further comprises scanning said part to be replaced to acquire dimensional information about the part to be replaced.

15. A method of developing a plan for repairing a product as set forth in claim 14 further comprising removing the part to be replaced from the product before scanning the part to be replaced.

16. A method of developing a plan for repairing a product as set forth in claim 14 further comprising removing the part to be replaced from the product after scanning of the part to be replaced and scanning of the part to be replaced includes acquiring information about a position and orientation of the part to be replaced.

17. A method of developing a plan for repairing a product as set forth in claim 16 further comprising removing the part to be replaced from the receiving portion of the product and attaching the preferred replacement part to the receiving portion of the product, wherein the attaching step includes using at least on of said dimensional, positional, and orientational information to position and orient the preferred replacement part on the product.
